(19) United States
(12) Patent Application Publication
(10) Pub. No.: US 2007/0092110 A1
(43) Pub. Date: Apr. 26, 2007

(54) Object tracking within video images

(76) Inventors: Li-Qun Xu, Ipswich (GB); Jose Luis Landabaso, Barcelona (ES)

Correspondence Address: NIXON & VANDERHYE, PC, 901 NORTH GLEBE ROAD, 11TH FLOOR, ARLINGTON, VA, 22203, US

(21) Appl. No.: 10/577,733

(22) PCT Filed: Nov. 8, 2004
(86) PCT No.: PCT/GB04/04687

§ 371 Date: May 2, 2006

(51) Int. Cl. G06K 9/00

(52) U.S. Cl. 382/103

(57) ABSTRACT

This invention provides an object tracking method and system for tracking objects in video frames which takes into account the scaling and variance of each matching feature. This provides for some latitude in the choice of matching feature, whilst ensuring that as many matching features as possible can be used to determine matches between objects, thus giving increased accuracy in the matching thus determined. A parallel matching approach is used, and heuristic rules employed to account for occlusions between objects.

### TECHNICAL FIELD

This invention relates to a method and system for tracking objects detected within video images from frame to frame.

### BACKGROUND TO THE INVENTION

Automated video tracking applications are known in the art. Generally, such applications receive video frames as input, and act to detect objects of interest within the image, such as moving objects or the like, frequently using background subtraction techniques. Having detected an object within a single input frame, such applications further act to track detected objects from frame to frame, using characteristic features of the detected objects. By detecting objects in future input frames, and determining the characteristic features of the detected objects, matching of the future detected objects with previously detected objects to produce a track is possible, by matching the determined characteristic features. An example prior art tracking application representative of the above is described within Zhou Q. et al. “Tracking and Classifying Moving Objects from Video”, Procs ₂^{nd} IEEE Int. Workshop on PETS, Kauai, Hi., USA, 2001.

However, matching using characteristic features poses some problems, as some features are more persistent for an object while others may be more susceptible to noise. Also, different features normally assume values in different ranges with different variances. A Euclidean distance matching measure does not account for these factors as it will allow dimensions with larger scales and variances to dominate the distance measure.

### SUMMARY OF THE INVENTION

The present invention addresses the above by the provision of an object tracking method and system for tracking objects in video frames which takes into account the scaling and variance of each matching feature. This provides for some latitude in the choice of matching feature, whilst ensuring that as many matching features as possible can be used to determine matches between objects, thus giving increased accuracy in the matching thus determined.

In view of the above, from a first aspect the present invention provides a method for tracking objects in a sequence of video images, comprising the steps of:

storing one or more object models relating to objects detected in previous video images of the sequence, the object models comprising values of characteristic features of the detected objects and variances of those values;

receiving a further video image of the sequence to be processed;

detecting one or more objects in the received video image;

determining characteristic features of the detected objects;

calculating a distance measure between each detected object and each object model on the basis of the respective characteristic features using a distance function which takes into account at least the variance of the characteristic features;

matching the detected objects to the object models on the basis of the calculated distance measures; and

updating the object models using the characteristic features of the respective detected objects matched thereto so as to provide a track of the objects.

The use of the distance function which takes into account the variance of the characteristic features compensates for the larger scales and variances of some of the matching characteristic features when compared to others, and hence provides a degree of flexibility in the choice of features, as well as the ability to use as many different matching features as are available to perform a match.

In a preferred embodiment the distance measure is a scaled Euclidean distance. This provides the advantage that high-dimensional data can be processed by a computationally inexpensive process, suitable for real-time operation. Preferably the distance function is of the form:

$$D ( l , k ) = \sqrt{{\sum }_{i = 1}^{N} \frac{{( {x}_{li} - {y}_{ki} )}^{2}}{{σ}_{li}^{2}}}$$

for object model l and detected object k, and where the index i runs through all the N features of an object model, and σₗᵢ² is the corresponding component of the variance of each feature.

In an alternative embodiment the distance measure is the Mahalanobis distance, which takes into account not only the scaling and variance of a feature, but also the variation of other features based on the covariance matrix. Thus, if there are correlated features, their contribution is weighted appropriately.

Preferably, there is further included the step of predicting the values of the characteristic features of the stored object models for the received frame; wherein the calculating step uses the predicted values of the characteristic features as the feature values from the object models. By using prediction to predict the values of the characteristic features for each object model for use with the present incoming frame the accuracy of matching of object model to detected object can be increased.

In a preferred embodiment, if an object model is not matched to a detected object then the variances of the characteristic feature values of that object are increased. This provides the advantage that it assists the tracker in recovering lost objects that may undergo sudden or unexpected movements.

Preferably, if an object model is not matched to a detected object in the received image then the updating step comprises updating the characteristic feature values with an average of each respective value found for the same object over a predetermined number of previous images. This provides for compensation in the case of prediction errors, by changing the prediction model to facilitate re-acquiring the object.

Moreover, preferably if an object model is not matched to a detected object in the received image then a test is performed to determine if the object is overlapped with another object, and the object is considered as occluded if an overlap is detected. This provides some flexibility in the track of an object, in that instead of the routine which would ultimately lead to the object being confirmed lost being commenced, if the object is occluded then the tracking technique recognises this as such, and does not immediately remove the object track.

Furthermore, the method preferably further comprises counting the number of consecutive video images for which each object is tracked, and outputting a tracking signal indicating that tracking has occurred if an object is tracked for a predetermined number of consecutive frames. This allows short momentary object movements to be discounted.

Additionally, if an object model is not matched to a detected object in the received image then preferably a count of the number of consecutive frames for which the object model is not matched is incremented, the method further comprising deleting the object model if the count exceeds a predetermined number. This allows for stationary objects which have become merged with the background and objects that have left the field of view to be discounted by pruning the stored object models relating to such objects, thus maintaining computational efficiency of the technique, and contributing to real-time capability.

Finally, if a detected object is not matched to an object model then preferably a new object model is stored corresponding to the detected object. This allows for new objects to enter the field of view of the image capture device and to be subsequently tracked.

From a second aspect the present invention also provides a system for tracking objects in a sequence of video images, comprising:

storage means for storing one or more object models relating to objects detected in previous video images of the sequence, the object models comprising values of characteristic features of the detected objects and variances of those values;

means for receiving a further video image of the sequence to be processed; and

processing means arranged in use to:
detect one or more objects in the received video image;
determine characteristic features of the detected objects;
calculate a distance measure between each detected object and each object model on the basis of the respective characteristic features using a distance function which takes into account at least the variance of the characteristic features;
match the detected objects to the object models on the basis of the calculated distance measures; and
update the stored object models using the characteristic features of the respective detected objects matched thereto.

Within the second aspect the same advantages, and same further features and advantages are obtained as previously described in respect of the first aspect.

From a third aspect the present invention also provides a computer program or suite of programs arranged such that when executed on a computer system the program or suite of programs causes the computer system to perform the method of the first aspect. Moreover, from a further aspect there is also provided a computer readable storage medium storing a computer program or suite of programs according to the third aspect. The computer readable storage medium may be any suitable data storage device or medium known in the art, such as, as a non-limiting example, any of a magnetic disk, DVD, solid state memory, optical disc, magneto-optical disc, or the like.

### BRIEF DESCRIPTION OF THE DRAWINGS

Further features and advantages of the present invention will become apparent from the following description of an embodiment thereof, presented by way of example only, and by reference to the accompanying drawings, wherein:

FIG. 1 is a system block diagram illustrating a computer system according to the present invention;

FIG. 2(a) and (b) are a flow diagram illustrating the operation of the tracking method and system of the embodiment of the invention;

FIG. 3 is a drawing illustrating the concept of object templates being matched to detected object blobs used in the embodiment of the invention;

FIG. 4 is a frame of an video sequence showing the tracking performed by the embodiment of the invention; and

FIG. 5 is a later frame of the video sequence including the frame of FIG. 4, again illustrating the tracking of objects performed by the invention.

### DESCRIPTION OF AN EMBODIMENT

An embodiment of the present invention will now be described with respect to the figures, and an example of the operation of the embodiment given.

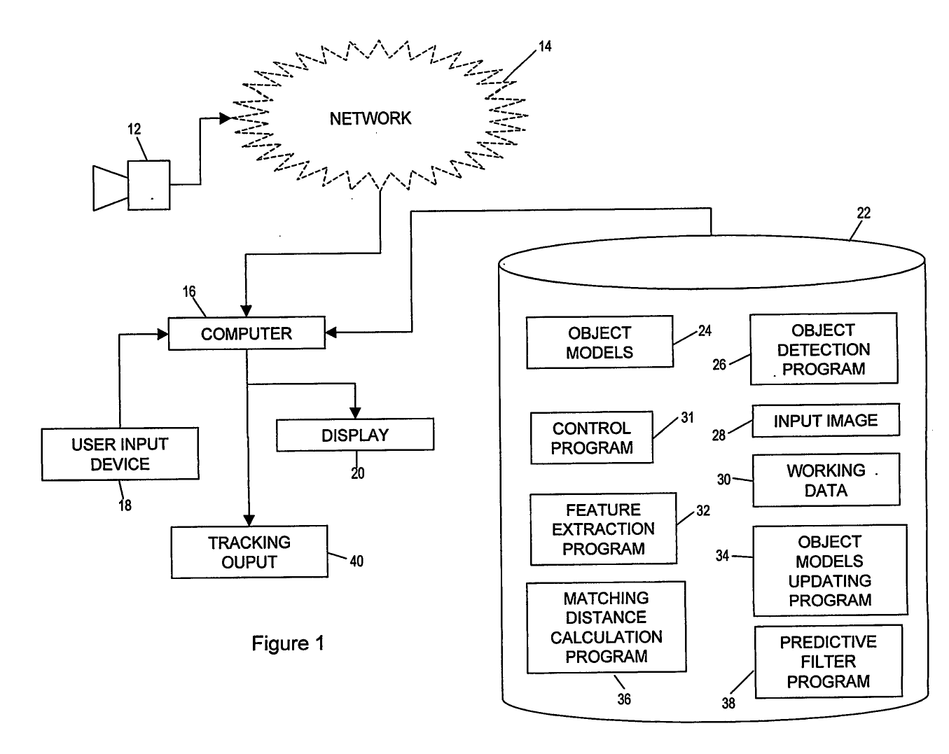

FIG. 1 illustrates an example system architecture which provides the embodiment of the invention. More particularly, as the present invention generally relates to an image processing technique for tracking objects within input images, the invention is primarily embodied as software to be run on a computer. Therefore, the system architecture of the present invention comprises a general purpose computer 16, as is well known in the art. The computer 16 is provided with a display 20 on which output images generated by the computer may be displayed to a user, and is further provided with various user input devices 18, such as keyboards, mice, or the like. The general purpose computer 16 is also provided with a data storage medium 22 such as a hard disk, memory, optical disk, or the like, upon which is stored programs, and data generated by the embodiment of the invention. An output interface 40 is further provided by the computer 16, from which tracking data relating to objects tracked within the images by the computer may be output to other devices which may make use of such data.

On the data storage medium 22 are stored data 24 corresponding to stored object models (templates), data 28 corresponding to an input image, and data 30 corresponding to working data such as image data, results of calculations, and other data structures or variables or the like used as intermediate storage during the operation of the invention. Additionally stored on the data storage medium 22 is executable program code in the form of programs such as a control program 31, a feature extraction program 32, a matching distance calculation program 36, an object detection program 26, an object models updating program 34, and a predictive filter program 38. The operation of each of these programs will be described in turn later.

In order to facilitate operation of the embodiment, the computer 16 is arranged to receive images from an image capture device 12, such as a camera or the like. The image capture device 12 may be connected directly to the computer 16, or alternatively may be logically connected to the computer 16 via a network 14 such as the internet. The image capture device 12 is arranged to provide sequential video images of a scene in which objects are to be detected and tracked, the video images being composed of picture elements (pixels) which take particular values so as to have particular luminance and chrominance characteristics. The colour model used for the pixels output from the image capture device 12 may be any known in the art e.g. RGB, YUV, etc.

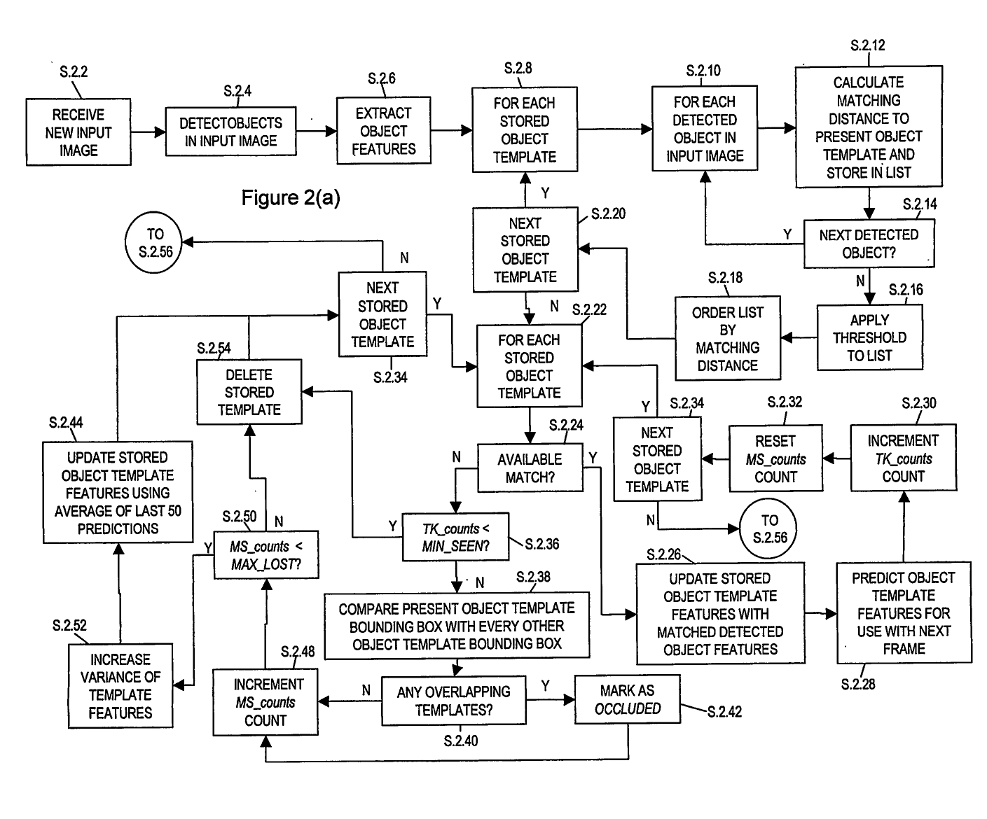

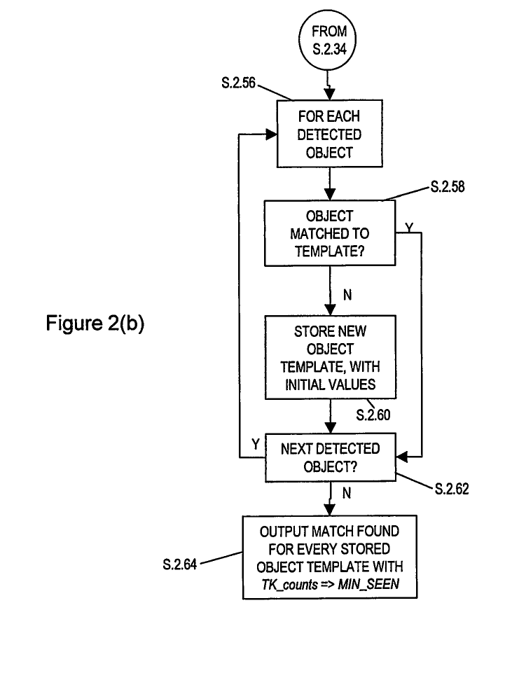

In operation, the general purpose computer 16 receives images from the image capture device 12 via the network, or directly, and runs the various programs stored on the data storage medium 22 under the general control of the control program 31 so as to process the received input image in order to track objects therein. A more detailed description of the operation of the embodiment will now be undertaken with respect to FIGS. 2 and 3.

With reference to FIG. 2, at step 2.2 a new video image is received from the image capture device 12, forming part of a video sequence being received from the device. For the sake of this description, we assume that previous images have been received, and that objects have previously been detected and tracked therein; a brief description of the start-up operation when the first images of a sequence are received is given later.

Following step 2.2, the first processing to be performed is that objects of interest (principally moving objects) need to be detected within the input image, a process generally known as “segmentation”. Any segmentation procedure already known in the art may be used, such as those described by McKenna et al. in “Tracking Groups of People”, Computer Vision and Image Understanding, 80, 42-56, 2000 or by Horpraset et al. in “A Statistical Approach for Real-time Robust Background Subtraction and Shadow Detection” IEEE ICCV'99 FRAME_{—}RATE workshop. Alternatively, and preferably, however, an object detection technique as described in the present applicant's co-pending international patent application filed concurrently herewith and claiming priority from U.K. application 0326374.4 may also be used. Whichever technique is employed, at step 2.4 object detection is performed by the object detection program 26 to link all the pixels presumably belonging to individual objects into respective blobs.

The purpose of the following steps is then to temporally track respective blobs representing objects throughout their movements within the scene by comparing feature vectors for the detected objects with temporal templates (object models). The contents of the object templates is discussed below.

In the present embodiment, a set of five significant features is used describing the velocity, shape, and colour of each detected object (candidate blob), namely:

the velocity v=(vₓ,v_{y}) at its centroid (pₓ,p_{y});

the size, or number of pixels, contained (s);

the ratio of the major-axis to minor-axis of the ellipse (r) that best fits the blob—this ratio of the ellipse better describes an object than the aspect ratio of its bounding box;

the orientation of the major-axis of the ellipse (θ); and

the dominant colour representation (cₚ), using the principal eigenvector of the aggregated pixels' colour covariance matrix of the blob.

At step 2.6 the feature extraction program 32 acts to detect the object matching characteristic features, as outlined above i.e. for a candidate blob k in frame t+1, centred at (p′ₖₓ,p′_{ky}) the feature vector Bₖ(t+1)=(v′ₖ,s′ₖ,r′ₖ,θ′ₖ,c′ₚ) is detected. Note that a respective feature vector is determined for every detected object in the present input frame t+1. The velocity of the candidate blob k is calculated as,
v′ₖ=(p′ₖₓ,p′_{ky})^{T}−(pₜₓ,p_{ty})^{T}.
Fitting of an ellipse to determine r and ⊖ may be performed as described in Fitzgibbon, A. W. and Fisher, R. B., “A buyer's guide to conic fitting”, Proc. 5^{th} British Machine Vision Conference, Birmingham, pp. 513-522 (1995). For explanation of methods of determining c, see Zhou Q. and Aggarwal, J. K., “Traching and classifying moving objects from video”, Proc. 2nd IEEE Intl. Workshop on Performance Evaluation of Tracking and Surveillance (PETS '2001), Kauai, Hi., U.S.A. (December 2001).

Having calculated the detected objects' feature vectors, it is then possible to begin matching the detected objects to the tracked objects represented by the stored object templates. More particularly, and as shown in FIG. 3, each object of interest that has been previously tracked within the scene represented by the input images is modelled by a temporal template of persistent characteristic features. At any time t, we have, for each tracked object l centred at (pₜₓ,p_{ty}), a template of features:
Mₗ (t)=(vₗ,sₗ,rₗ,θₗ,cₚ)

These object models (or templates) are stored in the data storage medium 22 in the object models area 24.

Prior to matching the template Mₗ with a candidate blob k in frame t+1, centred at (p′ₖₓ,p′_{ky}) with a feature vector Bₖ(t+1)=(V′ₖ,s′ₖ,r′ₖ,θ′ₖ,c′ₚ), Kalman filters are used to update the template by predicting, respectively, its new velocity, size, aspect ratio, orientation in \hat{M}ₗ(t+1). Here it is assumed that \hat{M}ₗ(t+1) has already been predicted and stored. Additionally, the stored object models also include the mean M̅ₗ(t) and variance Vₗ(t) vectors; these values are updated whenever a candidate blob k in frame t+1 is found to match with the template. Therefore, at step 2.8 the matching distance calculation program 36 is launched, which commences a FOR processing loop which generates an ordered list of matching distances for every stored object template with respect to every detected object in the input image. More particularly, at the first iteration of step 2.8 the first stored object template is selected, and its feature vector retrieved. Then, at step 2.10 a second nested FOR processing loop is commenced, which acts to step through the feature vectors of every detected object, processing each set in accordance with step 2.12. At step 2.12 a matching distance value is calculated between the present object. template and the present detected object being processed, by comparing the respective matching features to determine a matching distance therebetween. Further details of the matching function applied at step 2.12 are given next.

Obviously, some features are more persistent for an object while others may be more susceptible to noise. Also, different features normally assume values in different ranges with different variances. Euclidean distance does not account for these factors as it will allow dimensions with larger scales and variances to dominate the distance measure.

One way to tackle this problem is to use the Mahalanobis distance metric, which takes into account not only the scaling and variance of a feature, but also the variation of other features based on the covariance matrix. Thus, if there are correlated features, their contribution is weighted appropriately. In an alternative embodiment such a distance metric may be employed.

However, with high-dimensional data, the covariance matrix can become non-invertible. Furthermore, matrix inversion is a computationally expensive process, not suitable for real-time operation. So, in the present embodiment a scaled Euclidean distance, shown in Eq. (2), between the template \hat{M}ₗ(t+1)and a candidate blob k is adopted. For a heterogeneous data set, this is a reasonable distance definition.

$$D ( l , k ) = \sqrt{{\sum }_{i = 1}^{N} \frac{{( {x}_{li} - {y}_{ki} )}^{2}}{{σ}_{li}^{2}}} \qquad ( 2 )$$

where xₗᵢ and yₖᵢ are the scalar elements of the template \hat{M}ₗ and feature vector Bₖ respectively, σₗᵢ² is the corresponding component of the variance vector vₗ(t) and the index i runs through all the features of the template. Note that Equation (2) is the same result as given by the Mahalanobis distance in the case that there is no correlation between the features, whereupon the covariance matrix become a diagonal matrix. Thus Equation (2) represents a simplification by assuming that the features are uncorrelated. One exception to this formulation is the colour. This is processed by calculating the colour distance

$${d}_{lk} ( {c}_{l} , {c}_{k}^{′} ) = 1 - \frac{{c}_{l} \cdot {c}_{k}^{′}}{‖ {c}_{l} ‖ \cdot ‖ {c}_{k}^{′} ‖}$$

and using this instead of (xₗᵢ−yₖᵢ). The corresponding variance σₗᵢ is the variance of

$$\frac{{c}_{l} \cdot {c}_{k}^{′}}{‖ {c}_{l} ‖ \cdot ‖ {c}_{k}^{′} ‖} .$$

Following step 2.12, at step 2.14 an evaluation is performed to determine whether all of the detected objects have been matched against the present object template being processed i.e. whether the inner FOR loop has finished. If not, then the next detected object is selected, and the inner FOR loop repeated. If so, then processing proceeds to S.2.16.

At step 2.16 the present state of processing is that a list of matching distances matching every detected object against the stored object template currently being processed has been obtained, but this list is not ordered, and neither has it been checked to determine whether the distance measure values are reasonable. In view of this, at step 2.16 a threshold is applied to the distance values in the list, and those values which are greater than the threshold are pruned out of the list. A THR value of 10 proved to work in practice, but other values should also be effective. Following the thresholding operation, at step 2.18 the resulting thresholded list is ordered by matching distance value, using a standard sort routine.

Next, step 2.20 checks whether all of the stored object templates have been processed i.e. whether the outer FOR loop has finished. If not, then the next object template is selected, and the outer and inner FOR loops repeated. If so, then processing proceeds to S.2.22.

At this stage in the processing, we have, stored in the working data area 30, respective ordered lists of matching distances, one for each stored object model. Using these ordered lists it is then possible to match detected objects to the stored object models, and this is performed next.

More particularly, at step 2.22 a second FOR processing loop is commenced, which again acts to perform processing steps on each stored object template in turn. In particular, firstly at step 2.24 an evaluation is performed to determine whether the object model being processed has an available match. A match is made with the detected object which gave the lowest matching distance value in the present object model's ordered list. No match is available if, due to the thresholding step carried out previously, there are no matching distance values in the present object model's ordered list.

If the evaluation of step 2.24 returns true, i.e. present object l is matched by a candidate blob k in frame t+1, by way of the template prediction \hat{M}ₗ(t+1), variance vector Vₗ(t) and Bₖ(t+1), then processing proceeds to step 2.26 and the updates for the present object model l are performed. In particular, the object template for the present object is updated by the object models updating program 34 to obtain Mₗ(t +1)=Bₖ(t+1), as well as the mean and variance ( M̅ₗ(t+1),Vₗ(t+1)). These vectors are computed using the latest corresponding L blobs that the object has matched, or a temporal window of L frames (e.g., L=50). The template for each object being tracked has a set of associated Kalman filters that predict the expected value for each feature (except for the dominant colour) in the next frame, respectively. At step 2.28 the Kalman filters KFₗ(t) for the object model are also updated by feeding with the values of the matched detected object using the predictive filter program 38, and the predicted values \hat{M}ₗ for the features of the object model for use with the next input frame are determined and stored. Additionally, at step 2.30 a ‘TK_counts’ counter value representing the number of frames for which the object has been tracked is increased by 1, and an ‘Ms_counts’ counter which may have been set if the track of the object had been temporarily lost in the preceding few frames is set to zero at step 2.32. The FOR loop then ends with an evaluation as to whether all of the stored object templates have been processed, and if so processing proceeds to step 2.56 (described later). If all of the stored object templates have not been processed, then the FOR loop of s.2.22 is recommenced with the next stored object template to be processed.

Retuming to step 2.24, consider now the case where the evaluation of whether there is an available match returns a negative. In this case, as explained above, due to the thresholding applied to the list of distance measures for an object template there are no matching distances within the list i.e. no detected object matches to the object template within the threshold distance. In this case processing proceeds first to the evaluation of step 2.36, wherein the TK_counts counter for the present object template is evaluated to determine whether it is less than a predetermined value MIN_SEEN, which may take a value of 20 or the like. If TK_counts is less than MIN_SEEN then processing proceeds to step 2.54, wherein the present object template is deleted from the object model store 24. Processing then proceeds to step 2.34, shown as a separate step on the diagram, but in reality identical to that described previously above. This use of the MIN_SEEN threshold value is to discount momentary object movements and artefact blobs which may be temporarily segmented but which do not in fact correspond to proper objects to be tracked.

If the evaluation of step 2.36 indicates that the TK_counts counter exceeds the MIN_SEEN threshold then a test for occlusion is next performed, at step 2.38. In the present embodiment, no use is made of any special heuristics concerning the areas where objects enter/exit into/from the scene. Objects may just appear or disappear in the middle of the image, and, hence, positional rules are not necessary. To handle occlusions, therefore, the use of heuristics is essential. As a result within the embodiment every time an object has failed to find a match with a detected object a test on occlusion is carried out at step 2.38. Here, if the present object's bounding box overlaps with some other object's bounding box, as determined by the evaluation at step 2.40, then both objects are marked as ‘occluded’ at step 2.42. Processing then proceeds to step 2.48, which will be described below.

Returning to step 2.40, if the occlusion test indicates that there are no overlapping other templates i.e. the present object is not occluded, then the conclusion is drawn that the tracking of the object has been lost. Therefore, processing proceeds to s.2.48 where an MS_counts counter is incremented, to keep a count of the number of input frames for which the tracking of a particular object model has not been successful. At step 2.50 this count is compared with a threshold value MAX_LOST, which may take a value such as 5 or the like. If this evaluation indicates that the counter is greater than or equal to the threshold, then the conclusion is drawn that the tracking of the object has been irretrievably lost, and hence processing process to step 2.54, wherein the present object model is deleted, as previously described above.

If, however, the evaluation of step 2.50 indicates that the counter is less than MAX_LOST then processing proceeds to step 2.52, wherein the variance values of the object model are adjusted according to Eq. (3):
σᵢ²(t+1)=(1+δ)σᵢ²(t) (3)
where δ=0.05 is a good choice. This increase in the variance assists the tracker to recover lost objects that have undergone unexpected or sudden movements.

Following step 2.52, processing proceeds to step 2.44. Note also that step 2.44 can also be reached from step 2.42, where the present object model is marked as being occluded. As an error in the matching can occur simply due to the prediction errors, at step 2.44 the prediction model is changed to facilitate the possible recovery of the lost tracking. Hence within the MAX_LOST period, Kalman filters are not used to update the template of features but instead, at step 2.44 for each feature an average of the last 50 correct predictions is used, which states as Mₗ(t+1)=Mₗ(t)+ M̅ₗ(t). Moreover, if an object is marked as being occluded then the same update is performed. This is because occluded objects are better tracked using the averaged template predictions, as small erratic movements in the last few frames are then filtered out. Predictions of positions are also constrained within the occlusion blob.

Following step 2.44, processing proceeds to the evaluation of step 2.34, which has already been described.

Once the evaluation of step 2.34 indicates that every object template has been processed in accordance with the processing loop commenced at s.2.22, the present state of processing is that every stored object model will have been either matched with a detected object, marked as occluded, not matched but within the MAX_LOST period, or deleted from the object model store 24 (either by virtue of no match having been found within the MIN_SEEN period, or by virtue of the MAX_LOST period having been exceeded without the object having been re-acquired). However, there may still be detected objects in the image which have not been matched to a stored object model, usually because they are new objects which have just appeared within the image scene for the first time in the present frame (for example, a person walking into the image field of view from the side). In order to account for these unmatched detected objects, new object models must be instantiated and stored in the object model store.

To achieve this, following step 2.34 (once it indicates that every object template has been processed in accordance with the processing loop commenced at s.2.22) processing proceeds to step 2.56, wherein a further FOR processing loop is commenced, this time processing the detected objects. Within the processing loop the first step performed is that of step 2.58, which is an evaluation which checks whether the present detected object being processed has been matched to an object model. If this is the case i.e. the present object has been matched, then there is no need to create a new object model for the detected object, and hence processing proceeds to step 2.62. Step 2.62 determines whether or not all the detected objects have been processed by the FOR loop commenced at step 2.56, and returns the processing to step 2.56 to process the next detected object if not, or ends the FOR if all the detected objects have been processed.

If the present detected object has not been matched with a stored object model, however, then a new object model must be instantiated and stored at step 2.60, taking the detected object's feature values as it's initial values i.e. for the present detected object k in frame t+1, a new object template Mₖ(t+1) is created from Bₖ(t+1). The choice of initial variance vector Vₖ(t+1) for the new object needs some consideration, but suitable values can either be copied from very similar objects already in the scene or taken from typical values obtained by prior statistical analysis of correctly tracked objects, as a design option. The new object model is stored in the object model store 24, and hence will be available to be matched against when the next input image is received.

Following step 2.60 the loop evaluation of step 2.62 is performed as previously described, and once all of the detected object have been processed by the loop processing can proceed onto step 2.64. At this stage in the processing all of the stored object models have been matched to detected objects, marked as occluded or lost within the MAX_LOST period, or deleted, and all of the detected objects have either been matched to stored object models, or had new object models created in respect thereof. It is therefore possible at this point to output tracking data indicating the matches found between detected objects and stored object models, and indicating the position of tracked objects within the image. Therefore, at step 2.64 a tracking output is provided indicating the match found for every stored object template for which the TK_counts counter is greater than the MIN_SEEN threshold. As mentioned previously, the use of the MIN_SEEN threshold allows any short momentary object movements to be discounted, and also compensates for artefact temporarily segmented blobs which do not correspond to real objects. Moreover, as we have seen, object models are deleted if the tracking of the object to which they relate is lost (i.e. the object model is not matched) within the MIN_SEEN period. At start-up, of course, there are no templates stored. Initially, therefore, all objects detected are new objects and are processed in accordance with FIG. 2(b) to create new templates.

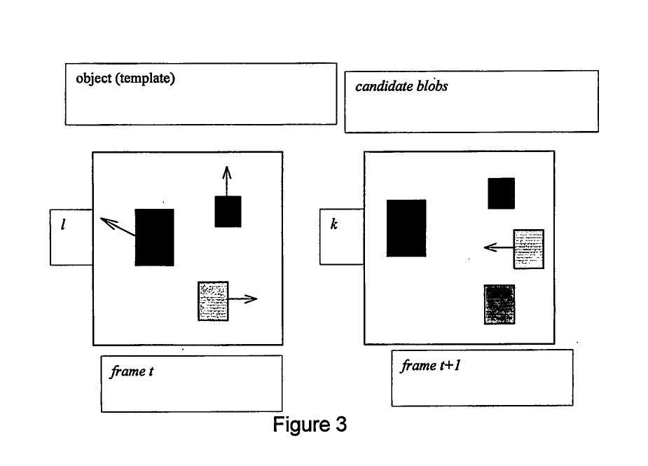

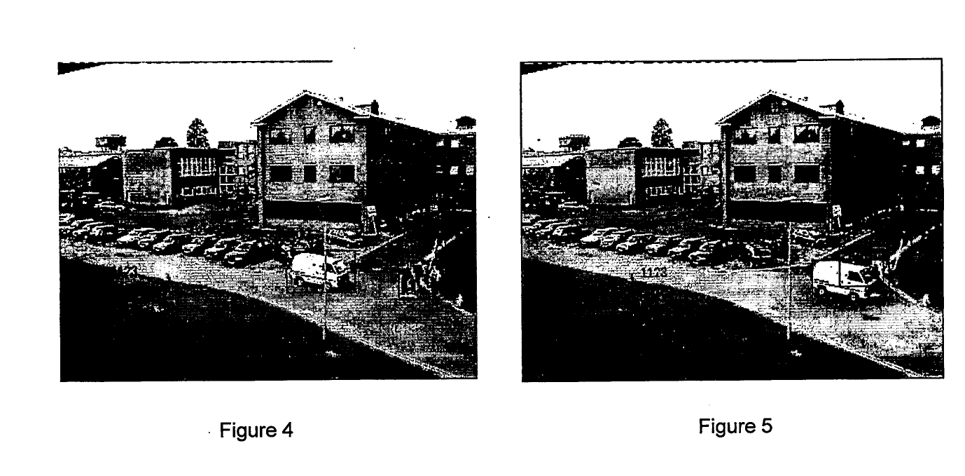

Within the embodiment the output tracking information is used to manipulate the image to place a visible bounding box around each tracked object in the image, as shown in FIGS. 4 and 5. FIGS. 4 and 5 are two frames from a video sequence which are approximately 40 frames temporally separated (FIG. 5 being the later frame). Within these images it will be seen that bounding boxes provided with object reference numbers have been placed around the tracked objects, and by a comparison of FIG. 4 to FIG. 5 it will be seen that the objects within the scene are tracked as they move across the scene (indicated here by the bounding boxes around each object having the same reference numbers in each image). Moreover, FIG. 5 illustrates the ability of the present embodiment to handle occlusions, as the group of people tracked as object 956 are occluded by the van tracked as object 787, but each object has still been successfully tracked.

As well as simply indicating that an object is being tracked by providing a visual output on the image, the tracking information provided by the embodiment may be employed in further applications, such as object classification applications or the like. Furthermore, the tracking information may be output at the tracking output 40 of the computer 16 (see FIG. 1) to other systems which may make use of it. For example the tracking information may be used as input to a device pointing system for controlling a device such as a camera or a weapon to ensure that the device remains pointed at a particular object in an image as the object moves. Other uses of the tracking information will be apparent to those skilled in the art.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A method for tracking objects in a sequence of video images, comprising the steps of:
storing object models relating to objects detected in previous video images of the sequence, the object models comprising values of characteristic features of the detected objects and variances of those values;
receiving a further video image of the sequence to be processed;
detecting objects in the received video image;
determining characteristic features of the detected objects;
calculating a distance measure between each detected object and each object model on the basis of the respective characteristic features using a distance function which takes into account at least the variance of the characteristic features;
matching the detected objects to the object models on the basis of the calculated distance measures; and
updating the object models using the characteristic features of the respective detected objects matched thereto.

2. A method according to claim 1, wherein the distance measure is a scaled Euclidean distance.

3. A method according to claim 2, wherein the distance function is of the form:
$$D ( l , k ) = \sqrt{{\sum }_{i = 1}^{N} \frac{{( {x}_{li} - {y}_{ki} )}^{3}}{{σ}_{li}^{2}}}$$
for object model l and detected object k, where xₗᵢ and yₖᵢ are values of the characteristic features of a stored object model and a detected object respectively, σₗᵢ² is the corresponding component of the variance of each feature, and the index i runs through N features of an object model.

4. A method according to claim 1, wherein the distance measure is the Mahalanobis distance.

5. A method according to claim 1, and further comprising the step of predicting the values of the characteristic features of the stored object models for the received frame; wherein the calculating step uses the predicted values of the characteristic features as the feature values from the object models.

6. A method according to claim 1, wherein if an object model is not matched to a detected object then the variances of the characteristic feature values of that object are increased.

7. A method according to claim 1, wherein if an object model is not matched to a detected object in the received image then the updating step comprises updating the characteristic feature values with an average of each respective value found for the same object over a predetermined number of previous images.

8. A method according to claim 1, wherein if an object model is not matched to a detected object in the received image then a test is performed to determine whether the object is overlapped with another object, and the object is considered as occluded if an overlap is detected.

9. A method according to claim 1, further comprising counting the number of consecutive video images for which each object is tracked, and outputting a tracking signal indicating that tracking has occurred if an object is tracked for a predetermined number of consecutive frames.

10. A method according to claim 1, wherein if an object model is not matched to a detected object in the received image then a count of the number of consecutive frames for which the object model is not matched is incremented, the method further comprising deleting the object model if the count exceeds a predetermined number.

11. A method according to claim 1, wherein if a detected object is not matched to an object model then a new object model is stored corresponding to the detected object.

12. A computer program or suite of computer programs arranged such that when executed on a computer it/they cause the computer to operate in accordance with claim 1.

13. A computer readable storage medium storing a computer program or at least one of a suite of computer programs according to claim 12.

14. A system for tracking objects in a sequence of video images, comprising:
storage means for storing object models relating to objects detected in previous video images of the sequence, the object models comprising values of characteristic features of the detected objects and variances of those values;
means for receiving a further video image of the sequence to be processed; and
processing means arranged in use to:
detect one or more objects in the received video image;
determine characteristic features of the detected objects;
calculate a distance measure between each detected object and each object model on the basis of the respective characteristic features using a distance function which takes into account at least the variance of the characteristic features;
match the detected objects to the object models on the basis of the calculated distance measures; and
update the stored object models using the characteristic features of the respective detected objects matched thereto.

15. A system according to claim 14, wherein the distance measure is a scaled Euclidean distance.

16. A system according to claim 15, wherein the distance function is of the form:
$$D ( l , k ) = \sqrt{{\sum }_{i = 1}^{N} \frac{{( {x}_{li} - {y}_{ki} )}^{2}}{{σ}_{li}^{2}}}$$
for object model l detected object k where xₗᵢ and yₖᵢ are values of the characteristic features of a stored object model and a detected object respectively, σₗᵢ² is the corresponding component of the variance of each feature, and the index i runs through N features of an object model.

17. A system according to claim 14, wherein the distance measure is the Mahalanobis distance.

18. A system according to claim 14, and further comprising means for predicting the values of the characteristic features of the stored object models for the received frame; wherein the processing means uses the predicted values of the characteristic features as the feature values from the object models within the distance measure calculation.

19. A system according to claim 14, wherein if an object model is not matched to a detected object then the variances of the characteristic feature values of that object are increased.

20. A system according to claim 14, wherein if an object model is not matched to a detected object in the received image then the updating step comprises updating the characteristic feature values with an average of each respective value found for the same object over a predetermined number of previous images.

21. A system according to claim 14, wherein if an object model is not matched to a detected object in the received image then a test is performed to determine if the object is overlapped with another object, and the object is considered as occluded if an overlap is detected.

22. A system according to claim 14, further comprising means for counting the number of consecutive video images for which each object is tracked, and means for outputting a tracking signal indicating that tracking has occurred if an object is tracked for a predetermined number of consecutive frames.

23. A system according to claim 14, wherein if an object model is not matched to a detected object in the received image then a count of the number of consecutive frames for which the object model is not matched is incremented, the system further comprising means for deleting the object model if the count exceeds a predetermined number.

24. A system according to claim 14, wherein if a detected object is not matched to an object model then a new object model is stored corresponding to the detected object.
